(19) United States
(12) Patent Application Publication
(10) Pub. No.: US 2021/0127594 A1
(43) Pub. Date: May 6, 2021

(54) SYSTEMS AND METHODS FOR PROVIDING A PERSONAL GROW POD

(71) Applicant: Grow Solutions Tech LLC, Vineyard, UT (US)

(72) Inventor: Gary Bret Millar, Highland, UT (US)

(73) Assignee: Grow Solultions Tech LLC, Vineyard, UT (US)

(21) Appl. No.: 17/150,076

(22) Filed: Jan. 15, 2021

Related U.S. Application Data
(63) Continuation of application No. PCT/US2019/042419, filed on Jul. 18, 2019.
(60) Provisional application No. 62/699,846, filed on Jul. 18, 2018.

(51) Int. Cl. A01G 7/04; H05B 45/22; H05B 47/125; A01G 9/24; A01G 27/00

(52) U.S. Cl. CPC A01G 7/045; H05B 45/22; A01G 27/003; A01G 9/247; H05B 47/125

(57) ABSTRACT

A personal grow pod system includes a plurality of compartments, a plurality of lighting devices corresponding to the plurality of compartments, and a controller including one or more processors, one or more memory modules, and machine readable instructions stored in the one or more memory modules. The controller is configured to identify plants in the plurality of compartments, retrieve recipes for each of the compartments based on the identified plants, and operate the plurality of lighting devices respectively based on the recipes for each of the compartments.

### CROSS-REFERENCE TO RELATED APPLICATION

This application is a continuation of International Application No. PCT/US2019/042419 filed on Jul. 18, 2019 which claims benefit of U.S. Provisional Application No. 62/699,846 filed on Jul. 18, 2018, the entire contents of which are herein incorporated by reference.

### TECHNICAL FIELD

Embodiments described herein generally relate to systems and methods for providing a personal grow pod and, more specifically, to growing customized plants in a plurality of cubic compartments based on recipes for the plants.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, a lay person may have difficult time growing various kinds of crops because different crops require different growing recipes such as lightings, nutrients, and the like. Thus, a personal grow pod kit for growing different kinds of crops may be needed.

### SUMMARY

In one embodiment, a personal grow pod system includes a plurality of compartments, a plurality of lighting devices corresponding to the plurality of compartments, and a controller including one or more processors, one or more memory modules, and machine readable instructions stored in the one or more memory modules. The controller is configured to identify plants in the plurality of compartments, retrieve recipes for each of the compartments based on the identified plants, and operate the plurality of lighting devices respectively based on the recipes for each of the compartments.

In another embodiment, a method for providing a personal grow pod is provided. The method includes identifying plants in a plurality of compartments; retrieving recipes for each of the cubic compartments based on the identified plants; and operating a plurality of lighting devices based on the recipes for each of the compartments. The plurality of lighting devices correspond to the plurality of compartments, respectively.

In another embodiment, a controller for a personal grow pod is provided. The controller includes one or more processors, one or more memory modules, and machine readable instructions stored in the one or more memory modules that, when executed by the one or more processors, cause the controller to: identify plants in the plurality of compartments; retrieve recipes for each of the compartments based on the identified plants; and operate the plurality of lighting devices respectively based on the recipes for each of the compartments.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts a personal grow pod system, according to embodiments shown and described herein;

FIG. 1B depicts a lid including a plurality of lighting devices that correspond to a plurality of cubic compartments, according to embodiments shown and described herein;

FIG. 2A depicts providing light in one of the cubic compartments of the personal grow pod system, according to embodiments described herein;

FIG. 2B depicts providing light in one of the cubic compartments of the personal grow pod system, according to embodiments described herein;

FIG. 3A depicts providing water and/or nutrients in one of the cubic compartments of the personal grow pod system, according to embodiments described herein;

FIG. 3B depicts providing water and/or nutrients in one of the cubic compartments of the personal grow pod system, according to embodiments described herein;

FIG. 4 depicts adjusting a base plate of a personal grow pod, according to embodiments described herein;

FIG. 5 depicts a flowchart for providing a personal grow pod, according to embodiments described herein; and

FIG. 6 depicts a computing device for an assembly line grow pod, according to embodiments described herein.

### DETAILED DESCRIPTION

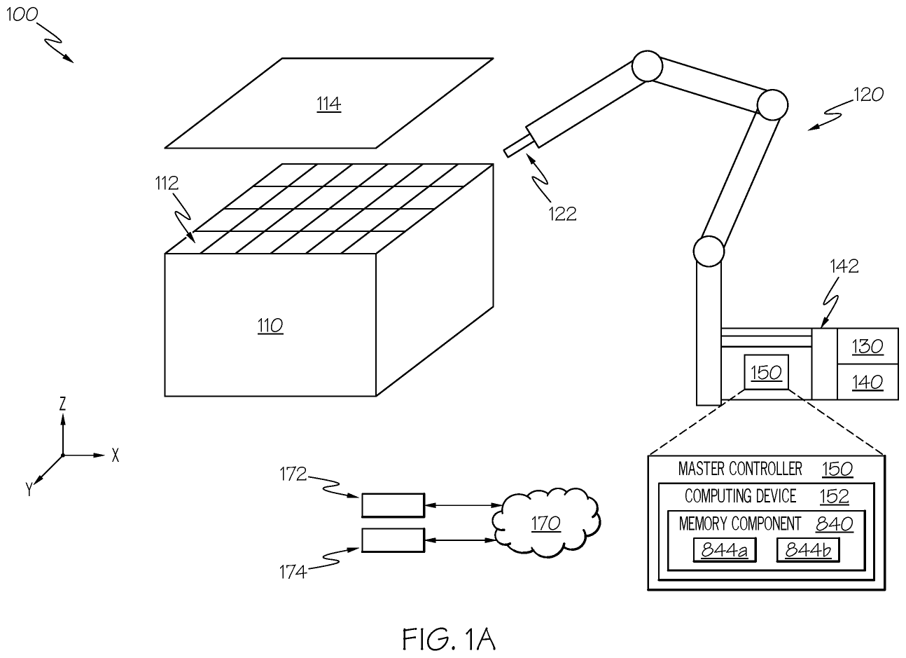

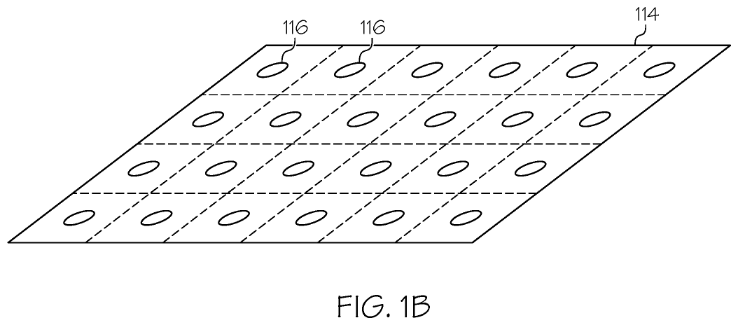

Embodiments disclosed herein include systems and methods for providing a personal grow pod. By referring to FIGS. 1A and 1B, a personal grow pod system 100 includes a plurality of cubic compartments 112, a plurality of lighting devices 116, a nutrient tank 140, a water tank 130, and a controller 150 configured to identify plants in the plurality of cubic compartments, retrieve recipes for each of the cubic compartments based on the identified plants, and provide water, nutrients, and/or lighting to the cubic compartments based on the recipes. The personal grow pod system 100 enables a lay person to grow various kinds of crops at the same time with the help of the controller automatically controlling lights, nutrients, and other factors based on recipes for different kinds of crops. The systems and methods for providing a personal grow pod incorporating the same will be described in more detail, below.

FIG. 1A depicts a personal grow pod system, according to embodiments shown and described herein. The personal grow pod system 100 includes a grow pod kit 110. The grow pod kit 110 may include a plurality of cubic compartments 112 for growing plants as shown in FIG. 1. While FIG. 1 depicts 24 cubic compartments, the grow pod kit 110 may include more than or less than about 24 cubic compartments. Each of the cubic compartments may include one or more seeds for growing. Each of the cubic compartments may be independently lighted using lighting devices which will be described in detail below.

The walls of the cubic compartments 112 may be opaque such that lighting in each of the cubic compartments does not interfere with lighting in other cubic compartments. A lid 114 for the plurality of cubic compartments 112 may be detachably coupled to the grow pod kit 110. The lid 114 may include a plurality of lighting devices 116 for directing light to each of the cubic compartments 112, as shown in FIG. 1B. In some embodiments, the grow pod kit 110 may include compartments having different shapes. For examples, the compartments of the grow pod kit 110 may be conical, cylindrical, and/or other regular or irregular shaped compartments. In some embodiments, each of the compartments has a water channel that is connected among multiple compartments such that a level of water is maintained evenly among those multiple compartments.

The personal grow pod system 100 may also include a robot arm 120 which is configured to provide seeds, water, and/or nutrients to each of the plurality of cubic compartments 112. The robot arm 120 may be positioned such that the robot arm 120 may reach to each of the plurality of the cubic compartments 112. In some embodiments, the robot arm 120 may be coupled to the grow pod kit 110. For example, the robot arm 120 may attached to the lid 114. In some embodiments, a movable robot having a robot arm may interact with the grow pod kit 110. For example, the movable robot picks up seeds, and/or nutrient solutions from a remote place and comes to the grow pod kit 110 and provide the seeds and/or nutrient solutions in the cubic compartments.

The robot arm 120 may include fingers (not shown) that hold seeds and put them into the plurality of cubic compartments 112. The robot arm 120 may include a nozzle 122 which supplies water and/or nutrients to each of the cubic compartments 112. The robot arm 120 may be connected to a water tank 130 which contains water and provides water to a water pipe of the robot arm 120. The water pipe is connected to the nozzle 122. The robot arm 120 may also include a nutrient tank 140 which contains nutrients and provides nutrients to the water pipe. A nutrient doser 142 may be connected to the robot arm 120. The nutrient doser 142 mix water from the water tank 130 and nutrients from the nutrient tank 140 to output a certain concentration of water/nutrient mixture.

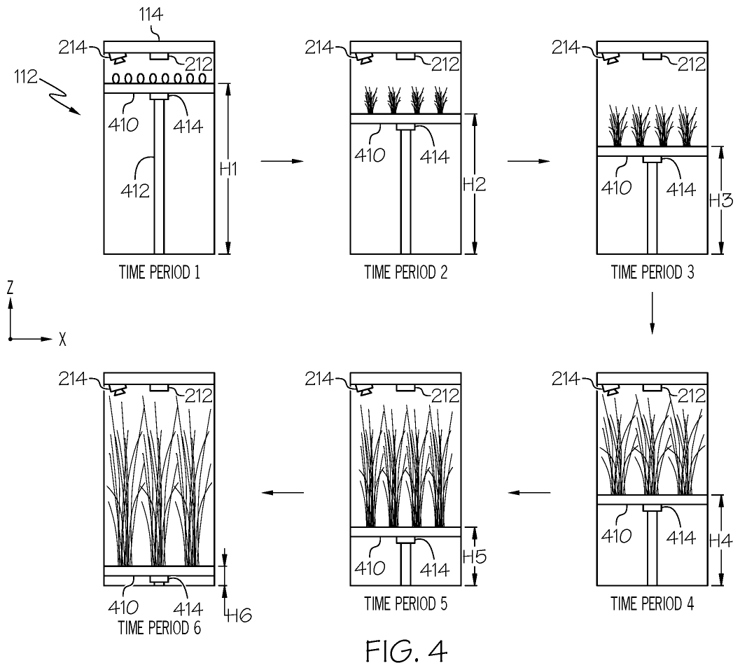

The robot arm 120 may include a master controller 150. The master controller 150 may include a computing device 152. The computing device 152 may include a memory component 840, which stores systems logic 844a and plant logic 844b. As described in more detail below, the systems logic 844a may monitor and control operations of the robot arm 120. For example, the systems logic 844a may monitor and control operations of the robot arm 120, the nozzle 122, the nutrient doser 142, lighting devices of the lid 114, and electric motors 414 (FIG. 4). The plant logic 844b may be configured to determine and/or receive a recipe for plant growth and may facilitate implementation of the recipe via the systems logic 844a. For example, a recipe for a plant determined by the plant logic 844b includes predetermined nutrient dosages, and the systems logic 844a may instruct the nutrient doser 142 to mix water with nutrients based on the nutrients dosages. As another example, a recipe for a plant determined by the plant logic 844b includes lighting recipes, and the systems logic 844a may instruct the lighting devices to output light of certain light characteristic to corresponding cubic compartments.

Additionally, the master controller 150 is coupled to a network 170. The network 170 may include the internet or other wide area network, a local network, such as a local area network, a near field network, such as Bluetooth or a near field communication (NFC) network. The network 170 is also coupled to a user computing device 172, a remote computing device 174, lighting devices 116 (FIG. 1B), and/or electric motors 414 (FIG. 4). The user computing device 172 may include a personal computer, laptop, mobile device, tablet, server, etc. and may be utilized as an interface with a user. As an example, a user may input nutrient dosages for plants in the cubic compartments on the user computing device 172 which in turn transmits the nutrient dosages to the master controller 150.

Similarly, the remote computing device 174 may include a server, personal computer, tablet, mobile device, etc. and may be utilized for machine to machine communications. As an example, if the master controller 150 determines a type of seed being used (and/or other information, such as ambient conditions), the master controller 150 may communicate with the remote computing device 174 to retrieve a previously stored recipe for those conditions. As such, some embodiments may utilize an application program interface (API) to facilitate this or other computer-to-computer communications.

The master controller 150 may identify the plants (e.g., as one of the types of plant matter A-D as shown in Table 1 below) in the plurality of cubic compartments 112 of the grow pod kit 110.

TABLE 1

| | Column | Column | Column | Column | Column | Column |
|---|---|---|---|---|---|---|
| | 1 | 2 | 3 | 4 | 5 | 6 |
| Row 1 | Plant A | Plant A | Plant A | Plant A | Plant A | Plant A |
| Row 2 | Plant A | Plant B | Plant B | Plant B | Plant B | Plant C |
| Row 3 | Plant C | Plant C | Plant C | Plant C | Plant D | Plant D |
| Row 4 | Plant D | Plant D | Plant A | Plant A | Plant A | Plant A |

For example, the master controller 150 may receive information about the plant matter from a user through the user computing device 172. As another example, the information about the plant matter in each of the cubic compartments 112 may be pre-stored in the master controller 150 when a seeder (not shown) seeds the plant matter in the each of the cubic compartments 112. As another example, imaging sensors on top of the cubic compartments 112 capture images of plants in each of the cubic compartments and transmit the captured images to the master controller 150. The master controller 150 processes the images to identify the plants in each of the cubic compartments.

The master controller 150 may store locations of each of the cubic compartments 112 and controls the robot arm 120 to correspond to one of the selected cubic compartments. For example, if it is determined that the Row 3, Column 2 cubic compartments need water/nutrient mixture, the master controller 150 may control the robot arm 120 to place the nozzle 122 in line with the Row 3, Column 2 cubic compartments.

Once the identification of plant matter in the each of the cubic compartments is determined, the master controller 150 instructs the nutrient doser 142 to mix water with nutrients based on nutrient dosages.

TABLE 2
Nutrient Dosages

| | Nutrients Concentration |
|---|---|
| Plant Matter A | 100 ppm of Nitrogen, 6 ppm of Phosphorus, |
| | 70 ppm of Potassium |
| Plant Matter B | 200 ppm of Nitrogen, 11 ppm of Phosphorus, |
| | 130 ppm of Potassium |
| Plant Matter C | 150 ppm of Nitrogen, 9 ppm of Phosphorus, |
| | 140 ppm of Potassium |
| Plant Matter D | 50 ppm of Nitrogen, 3 ppm of Phosphorus, |
| | 45 ppm of Potassium |

As one example, the master controller 150 may determine that cubic compartments of row 1, columns 1 through 6, row 2, column 1, and row 4, columns 3 through 6 contain plant matter A, as identified above in Table 1. Then, the master controller 150 instructs the nutrient doser 142 to mix water with nutrients to make water having 100 ppm of Nitrogen, 6 ppm of Phosphorus, and 70 ppm of Potassium based on the nutrient dosage for plant A, as shown in the Table 2 above. Then, the master controller 150 controls the robot arm 120 to provide the nutrient solutions to the cubic compartments that contain plant matter A. As another example, if the master controller 150 determines that the cubic compartments contain plant matter B, the master controller 150 instructs the nutrient doser 142 to mix water with nutrients to make water having 200 ppm of Nitrogen, 11 ppm of Phosphorus, 130 ppm of Potassium based on the nutrient dosage for plant matter B as shown in the Table 2 above. The nutrient doser 142 may change the nutrient concentration of water provided to the robot arm, in real-time according to the identification of plants being contained in the cubic compartments.

In embodiments, the nutrient dosages for plants may be updated based on information on harvested plants. For example, if the harvested plant matter A is generally smaller in size than an ideal plant matter A, the nutrient dosages for plant matter A may be adjusted to raise the concentration of Nitrogen, such as via a user input into the user computing device 172. As for another example, if the fruits of the harvested plant matter B are not as big as ideal fruits for the plant matter B, the nutrient dosages for plant matter B may be adjusted to raise the concentration of Phosphorus.

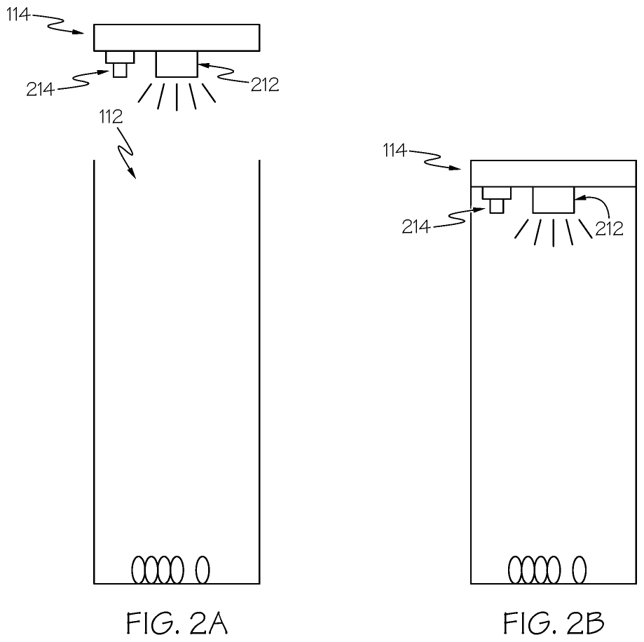

FIGS. 2A and 2B depict a cubic compartment 112 with a lid 114 having a lighting device 212 according to embodiments described herein. For each of the plurality of cubic compartments 112, a portion of the lid 114 corresponding to each of plurality of cubic compartments 112 may include the lighting device 212. The lighting device 212 may be communicatively coupled to the master controller 150. For example, the lighting device 212 may be communicatively coupled to the master controller 150 via Bluetooth, Wi-Fi, or any other short-distance wireless communication protocol. The lighting devices 212 may be in any shape, for example, round-shaped lighting devices, square-shaped lighting devices, etc. In embodiments, the lighting devices 212 may be light emitting devices (LEDs). In some embodiments, the lighting devices 212 may be any other type lighting devices such as incandescent lighting devices, fluorescent lighting devices, etc.

The master controller 150 stores lighting recipes for various plants and instructs the lighting device 212 to illuminate based on the lighting recipes. Specifically, the lighting device 212 illuminates based on a lighting recipe for the plant in the cubic compartment 112. The recipe may include a color of light, an intensity of light, and time period associated with the plant. For example, an LED RGB recipe for a plant matter A and an LED RGB recipe for plant matter B are shown in the Tables 3 and 4 below. The time period may be determined and/or preset for certain plants. For example, the time period 1 for plant A is 24 hours, and the time period 2 for plant A is 36 hours.

TABLE 3
LED RGB Recipe for plant A

| | Red | Blue | Green |
|---|---|---|---|
| Time period | intensity | intensity | intensity |
| Time period 1 | 80% | 20% | 0% |
| Time period 2 | 90% | 10% | 0% |
| Time period 3 | 95% | 5% | 0% |
| Time period 4 | 90% | 5% | 5% |
| Time period 5 | 85% | 5% | 10% |
| Time period 6 | 80% | 10% | 10% |

TABLE 4
LED RGB Recipe for plant B

| | Red | Blue | Green |
|---|---|---|---|
| Time period | intensity | intensity | intensity |
| Time period 1 | 80% | 15% | 5% |
| Time period 2 | 85% | 10% | 5% |
| Time period 3 | 83% | 7% | 10% |
| Time period 4 | 80% | 10% | 10% |
| Time period 5 | 80% | 15% | 5% |
| Time period 6 | 90% | 10% | 0% |

In some embodiments, time periods of growth may be set based on various types of growth, for example, height, chlorophyll production, root growth, fruit output, foliage, etc. For example, based on the height of a plant, the time periods of growth for the plant may be set, for example, time period 1 through time period 10. For each of time periods 1 through 10, lighting recipes may be assigned similar to Tables 3 and 4. As another example, based on the level of chlorophyll production, the time periods of growth for the plant may be set, for example, time periods 1 through 20. For each of time periods 1 through day 20, lighting recipes may be assigned similar to Tables 3 and 4.

Similarly, the recipe may also include a level of warm or cool white light. The level of warm white and the level of cool white may be set between 0 and 100. The level of warm white and the level of cool white may be set depending on the time periods of growth similar to Tables 3 and 4. In some embodiments, the recipe may be provided based on the stage of growth cycle (e.g., initialization, germination, growth, reproduction, etc.) instead of the time periods of growth.

The lid 114 may also include an imaging sensor 214, for example, a camera. For each of the plurality of cubic compartments 112, a portion of the lid 114 corresponding to each of plurality of cubic compartments 112 includes the imaging sensor 214. The imaging sensor 214 may be communicatively coupled to the master controller 150. For example, the imaging sensor 214 may be communicatively coupled to the master controller 150 via Bluetooth, Wi-Fi, or any other short-distance wireless communication protocol. The imaging sensor 214 may capture an image of the seed and/or plant in the cubic compartment 112 and transmit the captured image to the master controller 150.

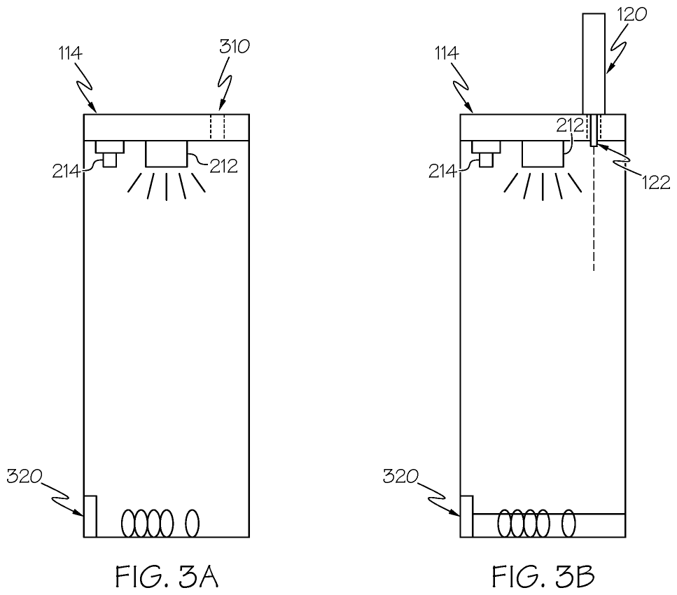

FIGS. 3A and 3B depict providing water/nutrient mixture into a cubic compartment according to embodiments described herein. In embodiments, the lid 114 includes an opening 310 that passes through the thickness of the lid 114. As shown in FIG. 3B, the opening 310 is configured to receive the nozzle 122 of the robot arm 120. Once the nozzle 122 is fit into the opening 310, the master controller 150 instructs the robot arm 120 to supply nutrients solution inside the cubic compartment 112. The cubic compartment 112 may include a fluid sensor 320 at the bottom of the cubic compartment.

The fluid sensor 320 detects the level of fluid inside the cubic compartment 112. For example, the fluid sensor 320 may be a circuit board or the like that contains various components, traces, and/or the like for testing for one or more indicators of a presence of fluid within the cubic compartment 112. The fluid sensor 320 may be communicatively coupled to the master controller 150 and transmit information about the level of water inside the cubic compartment. The master controller 150 may compare the level of water inside the cubic compartment with a first threshold level for the plant in the cubic compartment. If it is determined that the level of water inside the cubic compartment is less than a first threshold level, the master controller 150 may instruct the robot arm 120 to provide water into that cubic compartment. If it is determined that the level of water inside the cubic compartment is greater than a second threshold level which is greater than the second threshold level, the master controller 150 may instruct the robot arm 120 to remove water from the cubic department until the level of water becomes less than the second threshold value.

In some embodiments, the lid 114 may be pivotably coupled to the grow pod kit 110, and the robot arm 120 may open or close the lid 114 by lifting up or putting down the lid 114. Once the lid is opened, the robot arm 120 may provide water/nutrient mixture into the cubic compartments.

FIG. 4 depicts a cubic compartment where a base plate of moves vertically, according to embodiments described herein. In embodiments, the cubic compartment 112 includes a base plate 410 configured to move vertically along a guide 412. For example, the base plate 410 may move along a rail that corresponds to the guide 412. An electric motor 414 may be used to move the base plate 410 vertically. The electric motor 414 may be communicatively coupled to the master controller 150 to adjust the position of the base plate 410. For example, the electric motor 414 may be connected with the master controller 150 via a wire, and receive control signals from the master controller 150. As another example, the electric motor 414 may wirelessly communicate with the master controller 150, for example, via Wi-FI, Bluetooth, etc. The electric motor 414 may be controlled by the master controller 150 to adjust the position of the base plate 410. Other electronic or mechanical mechanism may be used to move the base plate 410 vertically. In some embodiments, a user may manually move the base plate 410, e.g., by lowering or raising a bar extended from the base plate 410.

In embodiments, the position of the base plate 410 may be determined based on at least one of the recipe for the plant in the cubic compartment 112, the time period of growth of the plant, and the height of the plant in the cubic compartment 112. For example, the recipe for the plant in the cubic compartment 112 may include a distance between the lighting device 212 and the base plate 410, as shown in Table 5 below.

| | Distance between a lighting |
|---|---|
| | device and a base |
| Time period 1 | 10 centimeters |
| Time period 2 | 20 centimeters |
| Time period 3 | 35 centimeters |
| Time period 4 | 40 centimeters |
| Time period 5 | 45 centimeters |
| Time period 6 | 50 centimeters |

The electric motor 414 may be controlled by the master controller 150 based on the recipe for the plant in the cubic compartment 112 and the time period of growth of the plant. For example, as shown in FIG. 4, during time period 1, the recipe for the plant in the cubic compartment 112 indicates 10 centimeters between the lighting device 212 and the base plate 410. The electric motor 414 operates to move the base plate 410 such that the distance between the lighting device 212 and the base plate 410 becomes 10 centimeters. At that time, the base plate 410 is at the height of H1 from the bottom of the cubic compartment, as shown in FIG. 4. Because of the short distance between the lighting device 212 and the base plate 410, the heat from the lighting device 212 may be efficiently transferred to the plants or seeds on the base plate 410 which helps germinating and growing of the plants.

During time period 2, the recipe for the plant in the cubic compartment 112 indicates 20 centimeters between the lighting device 212 and the base plate 410. The electric motor 414 operates to move the base plate 410 such that the distance between the lighting device 212 and the base plate 410 becomes 20 centimeters. At that time, the base plate 410 is at the height of H2 from the bottom of the cubic compartment. During time period 3, the recipe for the plant in the cubic compartment 112 indicates 35 centimeters between the lighting device 212 and the base plate 410. The electric motor 414 operates to move the base plate 410 such that the distance between the lighting device 212 and the base plate 410 becomes 35 centimeters. At that time, the base plate 410 is at the height of H3 from the bottom of the cubic compartment. During time period 4, the recipe for the plant in the cubic compartment 112 indicates 40 centimeters between the lighting device 212 and the base plate 410. The electric motor 414 operates to move the base plate 410 such that the distance between the lighting device 212 and the base plate 410 becomes 40 centimeters. At that time, the base plate 410 is at the height of H4 from the bottom of the cubic compartment. During time period 5, the recipe for the plant in the cubic compartment 112 indicates 45 centimeters between the lighting device 212 and the base plate 410. The electric motor 414 operates to move the base plate 410 such that the distance between the lighting device 212 and the base plate 410 becomes 45 centimeters. At that time, the base plate 410 is at the height of H5 from the bottom of the cubic compartment. During time period 6, the recipe for the plant in the cubic compartment 112 indicates 50 centimeters between the lighting device 212 and the base plate 410. The electric motor 414 operates to move the base plate 410 such that the distance between the lighting device 212 and the base plate 410 becomes 50 centimeters. At that time, the base plate 410 is at the height of H6 from the bottom of the cubic compartment.

In some embodiments, the electric motor 414 may be controlled by the master controller 150 based on the distance between the top of the plant and the lighting device 212 or the height of the plant. The distance between the top of the plant and the lighting device 212 may be measured by the imaging sensor 214, or other sensors such as proximity sensors that are attached to the lid 114. The master controller 150 may compare the distance between the top of the plant and the lighting device 212 with a threshold value. If it is determined that the distance between the top of the plant and the lighting device 212 is less than the threshold value, the master controller 150 may instruct the electric motor 414 to lower the base plate 410. For example, if it is determined that the distance between the top of the plant and the lighting device 212 is less than the threshold value of 5 centimeters in Time Period 1, the master controller 150 may instruct the electric motor 414 to lower the base plate 410 such that the base plate 410 is at the height of H2 as shown in FIG. 4.

In some embodiments, if it is determined that the distance between the top of the plant and the lighting device 212 is less than the threshold value, the master controller 150 may transmit a notification to the device of a user that the height of the base plate 410 needs to be adjusted.

While FIG. 4 depicts adjusting the height of the base plate 410, in some embodiments, the height of the lid 114 may be adjusted instead of the base plate 410 based on at least one of the recipe for the plant in the cubic compartment 112, the time period of growth of the plant, and the height of the plant in the cubic compartment 112.

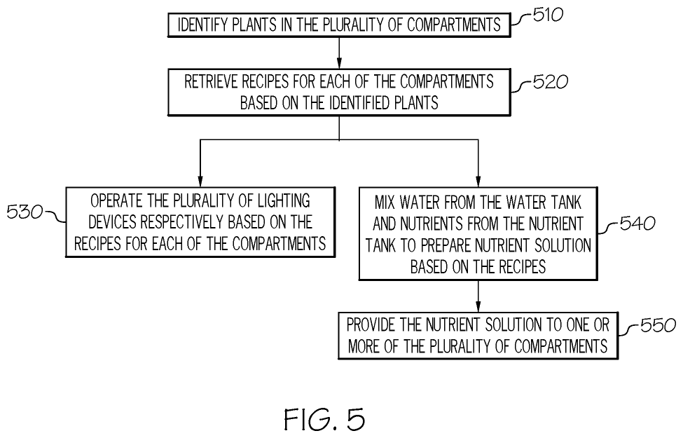

FIG. 5 depicts a flowchart for providing a personal grow pod according to embodiments described herein. In block 510, the master controller 150 identifies plants in the plurality of cubic compartments 112. For example, the master controller 150 may receive information about the plant matter from a user through the user computing device 172. As another example, the information about the plant matter in each of the cubic compartments 112 may be pre-stored in the master controller 150 when a seeder (not shown) seeds the plant matter in the each of the cubic compartments 112. As another example, imaging sensors on top of the cubic compartments 112 capture images of plants in each of the cubic compartments and transmit the captured images to the master controller 150. The master controller 150 processes the images to identify the plants in each of the cubic compartments. The master controller 150 may identify plants/seeds in each of the cubic compartments, e.g., as shown in Table 1 above.

In block 520, the master controller 150 retrieves recipes for each of the cubic compartments based on the identified plants. The recipes may include lighting recipes, nutrient recipes, etc. The recipes may be stored in the plant logic 844b (FIG. 1). For example, with respect to Row 1, Columns 1 through 6 cubic compartments, the master controller 150 retrieves recipes for plant A.

In block 530, the master controller 150 instructs the lighting devices 212 to provide light to cubic compartments based on the retrieved recipes. For example, the master controller 150 instructs the lighting devices 212 above Row 1, Columns 1 through 6 cubic compartments to providing light of characteristic determined based on recipes for plant A. In some embodiments, the master controller 150 instructs the electric motor 414 to adjust the position of the base plate 410 based on the retrieved recipes.

In block 540, the master controller 150 mixes water from the water tank 130 and nutrients from the nutrient tank 140 to prepare nutrient solution based on the recipes. For example, the master controller 150 may instruct the nutrient doser 142 to mix water from the water tank 130 and nutrients from the nutrient tank 140 to output a certain concentration of water/nutrient mixture.

In block 550, the master controller 150 provides the nutrient solution to one or more of the plurality of compartments. For example, the master controller 150 instructs the robot arm 120 to provide water/nutrient mixture that is determined based on recipes for plant A with respect to Row 1, Columns 1 through 6 cubic compartments.

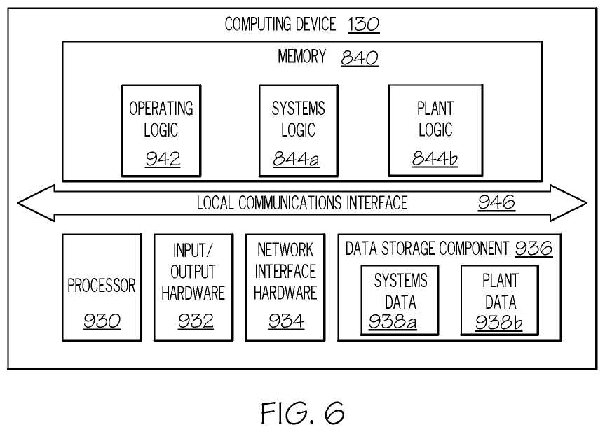

FIG. 6 depicts a master controller 150 for the personal grow pod system 100, according to embodiments described herein. As illustrated, the master controller 150 includes a processor 930, input/output hardware 932, the network interface hardware 934, a data storage component 936 (which stores systems data 938a, plant data 938b, and/or other data), and the memory component 840. The memory component 840 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the master controller 150 and/or external to the master controller 150.

The memory component 840 may store operating logic 942, the systems logic 844a, and the plant logic 844b. The systems logic 844a and the plant logic 844b may each include a plurality of different pieces of logic, each of which may be embodied as a computer program, firmware, and/or hardware, as an example. A local communication interface 946 is also included in FIG. 6 and may be implemented as a bus or other communication interface to facilitate communication among the components of the master controller 150.

The processor 930 may include any processing component operable to receive and execute instructions (such as from a data storage component 936 and/or the memory component 840). The input/output hardware 932 may include and/or be configured to interface with the robot arm 120 (FIG. 1), the nutrient doser 142 (FIG. 1) and/or other hardware.

The network interface hardware 934 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the master controller 150 and other computing devices, such as the user computing device 172 and/or remote computing device 174.

The operating logic 942 may include an operating system and/or other software for managing components of the master controller 150. As also discussed above, systems logic 844a and the plant logic 844b may reside in the memory component 840 and may be configured to performer the functionality, as described herein.

It should be understood that while the components in FIG. 6 are illustrated as residing within the master controller 150, this is merely an example. In some embodiments, one or more of the components may reside external to the master controller 150. It should also be understood that, while the master controller 150 is illustrated as a single device, this is also merely an example. In some embodiments, the systems logic 844a and the plant logic 844b may reside on different computing devices. As an example, one or more of the functionalities and/or components described herein may be provided by the user computing device 172 and/or remote computing device 174.

Additionally, while the master controller 150 is illustrated with the systems logic 844a and the plant logic 844b as separate logical components, this is also an example. In some embodiments, a single piece of logic (and/or several linked modules) may cause the master controller 150 to provide the described functionality.

As illustrated above, various embodiments for providing a personal grow pod are disclosed. These embodiments create a quick growing, small footprint, chemical free, low labor solution to growing microgreens and other plants for harvesting. These embodiments may create recipes and/or receive recipes that dictate the timing and wavelength of light, pressure, temperature, watering, nutrients, molecular atmosphere, and/or other variables the optimize plant growth and output. The recipe may be implemented strictly and/or modified based on results of a particular plant, tray, or crop.

Accordingly, some embodiments may include a personal grow pod system that includes a plurality of compartments, a plurality of lighting devices corresponding to the plurality of compartments, and a controller including one or more processors, one or more memory modules, and machine readable instructions stored in the one or more memory modules that, when executed by the one or more processors, cause the controller to: identify plants in the plurality of compartments, retrieve recipes for each of the compartments based on the identified plants, and operate the plurality of lighting devices respectively based on the recipes for each of the compartments. According to the present disclosure, a personal grow pod system helps a lay person to grow various kinds of crops at the same time with the help of the controller automatically controlling lights, nutrients, and other factors based on recipes for different kinds of crops. The system identifies each of plants in each compartments of the personal grow pods, respectively, and provides customized resources to each compartments, so that the user can grow various crops independently and efficiently.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

What is claimed is:

1. A personal grow pod system comprising:
a plurality of compartments;
a plurality of lighting devices corresponding to the plurality of compartments; and
a controller comprising
one or more processors;
one or more memory modules; and
machine readable instructions stored in the one or more memory modules that, when executed by the one or more processors, cause the controller to:
identify plants in the plurality of compartments;
retrieve recipes for each of the compartments based on the identified plants; and
operate the plurality of lighting devices respectively based on the recipes for each of the compartments.

2. The personal grow pod system of claim 1, further comprising a nutrient tank and a water tank,
wherein the machine readable instructions stored in the one or more memory modules, when executed by the one or more processors, cause the controller to:
mix water from the water tank and nutrients from the nutrient tank to prepare nutrient solution based on the recipes; and
provide the nutrient solution to one or more of the plurality of compartments.

3. The personal grow pod system of claim 2, further comprising a robot arm configured to supply the nutrient solution to each of the plurality of compartments.

4. The personal grow pod system of claim 1, wherein the plurality of compartments include a plurality of base plates configured to move vertically.

5. The personal grow pod system of claim 4, further comprising a plurality of actuators configured to move the plurality of base plates, respectively.

6. The personal grow pod system of claim 5, wherein the machine readable instructions stored in the one or more memory modules, when executed by the one or more processors, cause the controller to:
operate the plurality of actuators based on the recipes.

7. The personal grow pod system of claim 6, wherein the machine readable instructions stored in the one or more memory modules, when executed by the one or more processors, cause the controller to:
operate the plurality of actuators based on information about the identified plants in the plurality of compartments.

8. The personal grow pod system of claim 6, wherein the machine readable instructions stored in the one or more memory modules, when executed by the one or more processors, cause the controller to:
instruct the plurality of actuators to adjust the plurality of base plates further based on a distance between each of the plurality of lighting devices and a top of each of the plants in each of the plurality of compartments.

9. The personal grow pod system of claim 1, further comprising:
one or more imaging sensors configured to capture images of the plants in the plurality of compartments.

10. The personal grow pod system of claim 1, further comprising:
a cover plate configured to cover the plurality of compartments and including the plurality of lighting devices.

11. The personal grow pod system of claim 1, wherein the recipes include lighting recipes including intensities of red lighting, green lighting, and blue lighting.

12. A method for providing a personal grow pod, the method comprising:
identifying plants in a plurality of compartments;
retrieving recipes for each of the plurality of compartments based on the identified plants; and
operating a plurality of lighting devices based on the recipes for each of the compartments,
wherein the plurality of lighting devices correspond to the plurality of compartments, respectively.

13. The method of claim 12, further comprising
mixing water from a water tank and nutrients from a nutrient tank to prepare nutrient solution based on the recipes; and
providing the nutrient solution to one or more of the plurality of compartments.

14. The method of claim 12, wherein the plurality of compartments include a plurality of base plates configured to move vertically.

15. The method of claim 14, further comprising
adjusting a height of each of the plurality of base plates based on the recipes.

16. The method of claim 12, wherein the recipes include lighting recipes including intensities of red lighting, green lighting, and blue lighting.

17. A controller for a personal grow pod, the controller comprising
one or more processors;
one or more memory modules; and
machine readable instructions stored in the one or more memory modules that, when executed by the one or more processors, cause the controller to:
identify plants in a plurality of compartments of the personal grow pod;
retrieve recipes for each of the compartments based on the identified plants; and
operate a plurality of lighting devices of the personal grow pod respectively based on the recipes for each of the compartments.

18. The controller of claim 17, wherein the machine readable instructions stored in the one or more memory modules, when executed by the one or more processors, cause the controller to:
mix water from a water tank and nutrients from a nutrient tank to prepare nutrient solution based on the recipes; and
provide the nutrient solution to one or more of the plurality of compartments.

19. The controller of claim 17, wherein the machine readable instructions stored in the one or more memory modules, when executed by the one or more processors, cause the controller to:
operate a plurality of actuators configured to move a plurality of base plates for the plurality of compartments, respectively.

20. The controller of claim 17, wherein the machine readable instructions stored in the one or more memory modules, when executed by the one or more processors, cause the controller to:
receive images of the plants in the plurality of compartments; and
identify plants in the plurality of compartments based on the images.
